(19) United States
(12) Patent Application Publication
(10) Pub. No.: US 2015/0207236 A1
(43) Pub. Date: Jul. 23, 2015

(54) ANTENNA UNIT

(71) Applicant: THE UNIVERSITY OF MELBOURNE, Melbourne, Victoria (AU)

(72) Inventors: Gordana Felic, Melbourne (AU); Robin J. Evans, Melbourne (AU); Efstratios Skafidas, Melbourne (AU)

(21) Appl. No.: 14/417,087

(22) PCT Filed: Jul. 25, 2013
(86) PCT No.: PCT/AU2013/000827

§ 371 Date: Jan. 23, 2015

(30) Foreign Application Priority Data
Jul. 25, 2012 (AU) 2012903197

(51) Int. Cl. H01Q 19/06; H01Q 15/08

(52) U.S. Cl. CPC H01Q 19/062; H01Q 15/08

(57) ABSTRACT

An antenna unit (100) comprises an antenna substrate (140) carrying one or more radiating elements (150), and a lens structure formed of a dielectric material, the lens structure comprising a lens (110) and at least one support member (120) arranged to support the antenna substrate (140) at a displacement relative to the lens (110).

### FIELD

The present invention relates to an antenna unit for use in a radar apparatus.

### BACKGROUND

Low power chip-based radars are becoming increasingly popular and widespread, especially in the automotive industry for safety and comfort applications such as collision avoidance or adaptive cruise control for motor vehicles.

Such chip-based radars have the potential to become more widespread if their cost can be lowered and/or if they can more easily integrated into motor vehicles or the like.

In order to achieve the necessary gain and angle resolution it has been proposed to use reflector and lens based antennas in automotive radar applications. These antenna types use a low-gain feed (such as a horn or planar patch) to illuminate a large, dielectric structure to diverge the primary rays so that they become a set of secondary rays that produce a desirable secondary radiation pattern for the transmitted radar signals. Lens antennas accomplish this by forward-scattering the primary rays of the transmitted radar signals, the basic process being one of diffraction. For this reason, lens antennas have one inherent advantage over reflector type antennas because the feed is not in the path of the secondary rays.

An offset to this advantage lies in the fact that lens antennas are typically thicker, heavier, and more difficult to construct than reflectors.

The present invention aims to provide an alternative antenna unit.

### SUMMARY

In one aspect, the invention provides an antenna unit comprising:
an antenna substrate carrying one or more radiating elements; and
a lens structure formed of a dielectric material, the lens structure comprising a lens and at least one support member arranged to support the antenna substrate at a displacement relative to the lens.

In an embodiment, the support member is arranged to support the antenna substrate at a displacement relative to the lens where the plane of the antenna substrate intersects the focus of the lens.

In an embodiment, the lens is a hemispherical lens.

In an embodiment, said lens structure comprises a pair of walls extending from a base of the lens and joining the lens to a base member that provides the at least one support member.

In an embodiment, the antenna unit comprises a pair of recesses in the integral lens structure where the walls meet the base member, each recess for receiving a portion of the antenna substrate.

In an embodiment, the base member is annular.

In an embodiment, the one or more radiating elements are carried on an obverse, lens-facing side of the antenna substrate and at least one additional component is attached to a reverse side of the antenna substrate in a position where it extends into an interior of the annular base member.

In an embodiment, the at least one additional component comprises a chip for driving the one or more radiating elements and/or processing signals received from the one or more radiating elements.

In an embodiment, the lens is a hemicylindrical lens.

In an embodiment, said at least one support structure comprises a pair of walls extending from a base of the lens, each wall having a recess for receiving and supporting a portion of the antenna substrate.

In an embodiment, the one or more antenna elements are carried on an obverse, lens-facing side of the antenna substrate and at least one additional component is attached to a reverse side of the antenna substrate.

In an embodiment, the at least one additional component comprises a chip for driving the one or more radiating elements and/or processing signals received from the one or more radiating elements.

In an embodiment, the one or more radiating elements are provided by one or more series-fed patch arrays.

In an embodiment, the one or more radiating elements are provided by at least one 2×2 patch array.

In an embodiment, the lens structure is formed from a low dielectric material such as Teflon or Rexolite.

In another aspect, the invention provides a lens structure for an antenna unit, the lens structure being formed of a dielectric material, the lens structure comprising a lens and at least one support member arranged to support an antenna substrate at a displacement relative to the lens.

In an embodiment, the support member is arranged to support the antenna substrate at a displacement relative to the lens where the plane of the antenna substrate will intersect the focus of the lens.

In an embodiment, the lens is a hemispherical lens.

In an embodiment, the lens structure comprises a pair of walls extending from a base of the lens and joining the lens to a base member that provides the at least one support member.

In an embodiment, the lens structure comprises a pair of recesses in the lens structure where the walls meet the base member, each recess for receiving a portion of the antenna substrate.

In an embodiment, the base member is annular.

In an embodiment, the lens is a hemicylindrical lens.

In an embodiment, said at least one support structure comprises a pair of walls extending from a base of the lens and, each wall having a recess for receiving and supporting a portion of the antenna substrate.

In an embodiment, the lens structure is formed from a low dielectric material such as Teflon or Rexolite.

### BRIEF DESCRIPTION OF DRAWINGS

Embodiments of the invention will now be described with reference to the accompanying drawings in which:

FIG. 1A is a partially transparent perspective view of an antenna unit of a first embodiment;

FIG. 1B is a partially transparent side view of an antenna unit of a first embodiment;

FIG. 1C is a partially transparent top view of an antenna unit of a first embodiment;

FIG. 2A is a partially transparent perspective view of an antenna unit of a second embodiment;

FIG. 2B is an end view of an antenna unit of a second embodiment;

FIG. 3 is a plan view of an antenna substrate with two series-fed patch arrays of radiating antenna elements;

FIG. 4 is a plan view of an antenna substrate with a 2×2 patch array of radiating antenna elements;

FIG. 5 shows a hemispherical lens with two refracting surfaces; and

FIG. 6 shows a lens antenna radiation pattern in azimuth and elevation planes.

### DETAILED DESCRIPTION

In the embodiment, an improved antenna unit is provided by integrating a dielectric lens for an antenna into an lens structure formed of a dielectric material that incorporates both a lens and a support structure in a unitary body. The lens structure acts as a support (and in some embodiments as a housing) for an antenna substrate carrying radiating elements of the antenna, for example in the form of a primary printed array of radiating elements of the antenna. The antenna substrate is a planar substrate and may be a printed circuit board that provides baseband and digital signal circuits and may carry one or more additional components such as a CMOS chip for generating radar signals and/or processing reflected radar signals to obtain information about one or more targets.

The lens structure may be fabricated as a unitary body by using a 3-D printing or plastics moulding process.

In an embodiment suitable for automotive radar requirements, the radiating elements of the antenna may be a series-fed patch array. Such a series-fed patch array combined with a dielectric lens provided by the lens structure may provide high gain of above 20 dB.

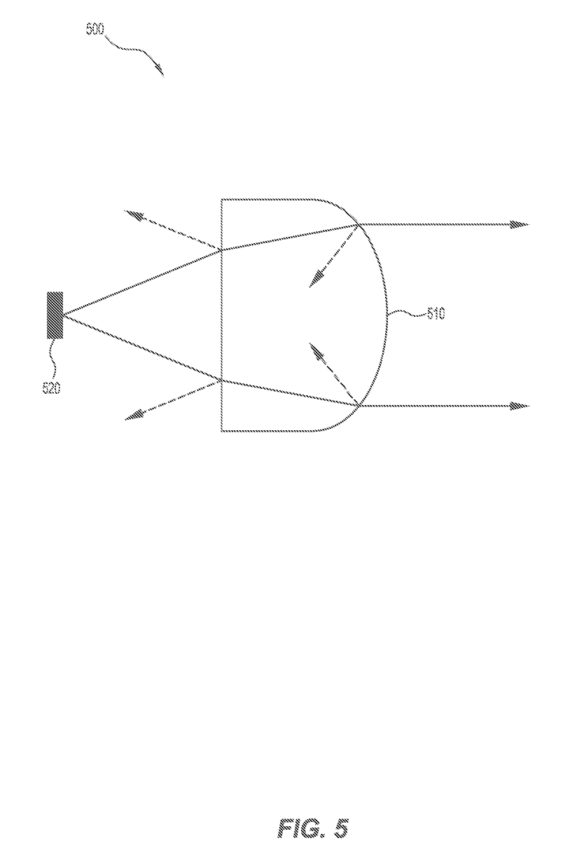

As illustrated schematically in FIG. 5, the gain and the 3 dB beam width of the dielectric lens provided by the lens structure depends on its size. The correlation between the radius r of 10-30 mm, and the 3 dB beam width (in the elevation plane) for a uniform illuminated circular lens can be estimated by:

$${θ}_{3 d B} = 57 \frac{λ}{2 r}$$

where λ is the wavelength at operating frequency and r is the radius of the lens. In order to achieve a high angle resolution and gain the 3 dB-beam width has to be a small as possible since the gain (directivity) is related to the 3 dB-beam width as:

$$D = \frac{41000}{{θ}_{3 d B} {φ}_{3 d B}}$$

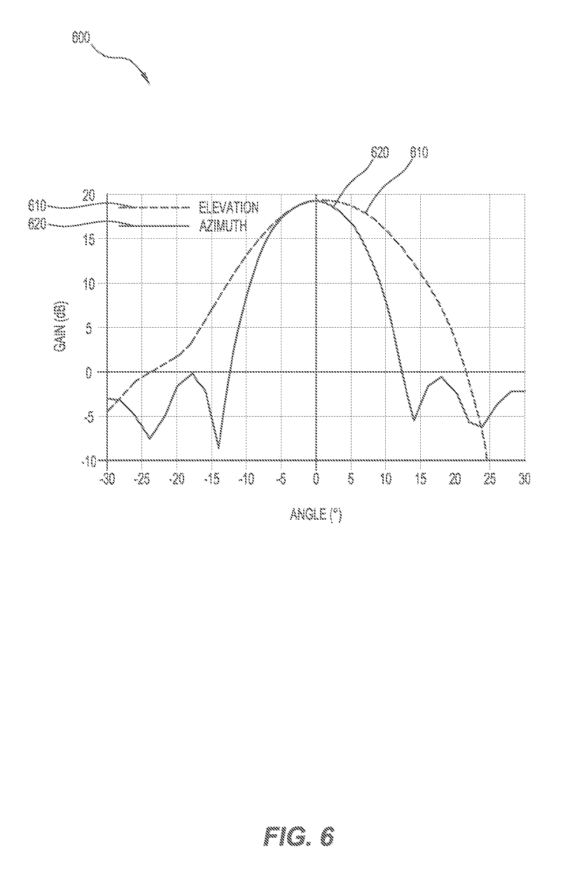

For example, to achieve the 20 dB directivity (gain) the 3 dB-beam width should be 10°. This can be achieved by using a hemispherical lens (plano-convex) made of a dielectric material such as Teflon which is low loss material and easy to manufacture and has a dielectric constant, ∈ᵣ=2.2. Based on the above example, a lens that may be employed in an embodiment is one where the hemispherical lens portion of the lens structure is 20 mm in diameter and the focal length is 10 mm. FIG. 6 shows the predicted gain versus angle in two principle planes for such a lens. As shown in FIG. 6, the maximal gain of the antenna is 20 dB and the 3 dB beam width is 10° in elevation and 18° in azimuth plane. Side lobe suppression is 18 dB.

To achieve suitable gain while keeping the overall dimensions of the antenna unit to a reasonable size, employ lens portions of lens structures of advantageous embodiments of the invention have a radius in the range of 10 mm to 15 mm and more advantageously in the range of 10 mm to 12 mm.

Persons skilled in the art will appreciate that materials other than Teflon may be employed for example, Rexolite (∈ᵣ=2.53), Foam (∈ᵣ=1.69), Silicon (∈ᵣ=11.7). In this respect, while low dielectric constant materials are preferred, cost is a more significant consideration.

While microstrip series-fed patches may be used to produce a shaped pattern, without a lens the patch array would have to be comprised of a considerably higher number of patch radiators. Accordingly, in the embodiment cascaded microstrip patch radiating elements are interconnected by half wavelength high-impedance T-lines. The design is based on the transmission line model and the equivalent circuit concept. The shape of the radiation pattern (3 db beam width and gain) is directly related to the number of patches.

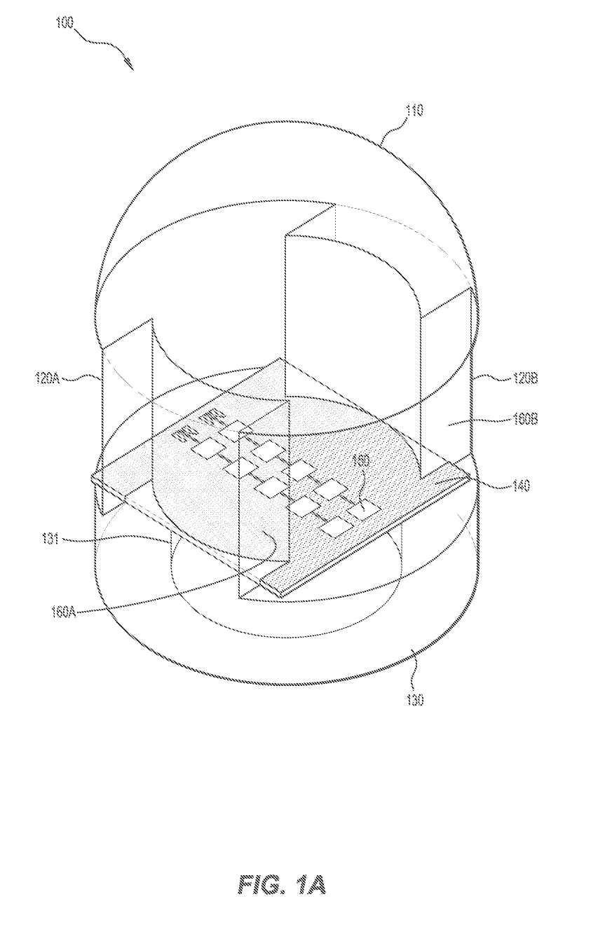

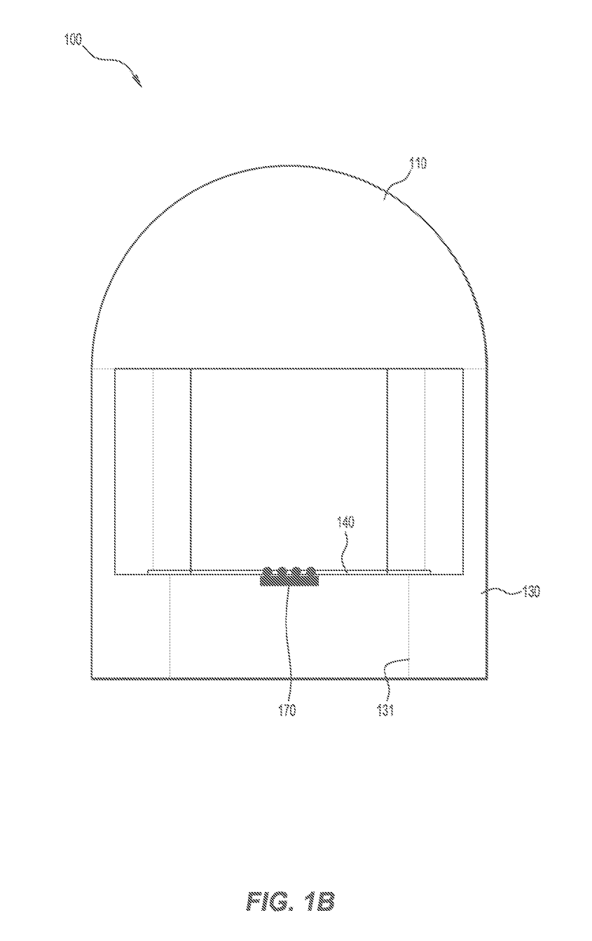

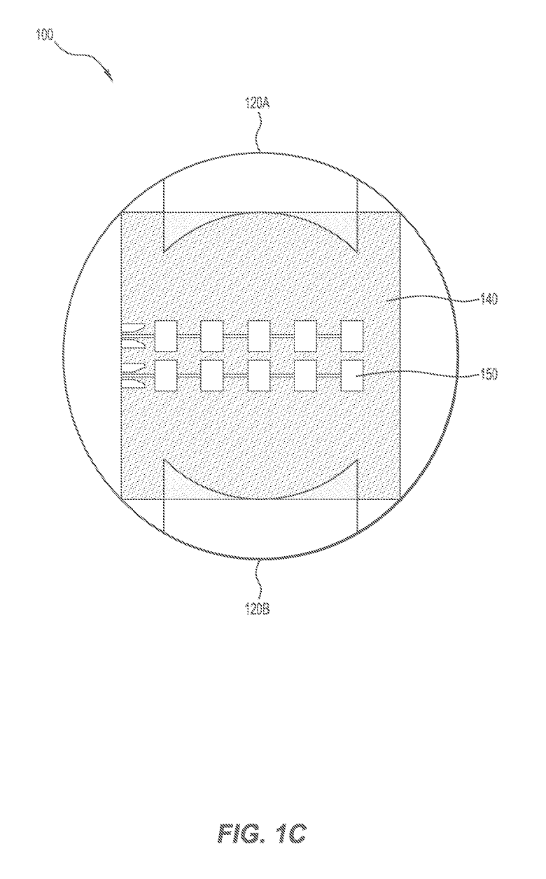

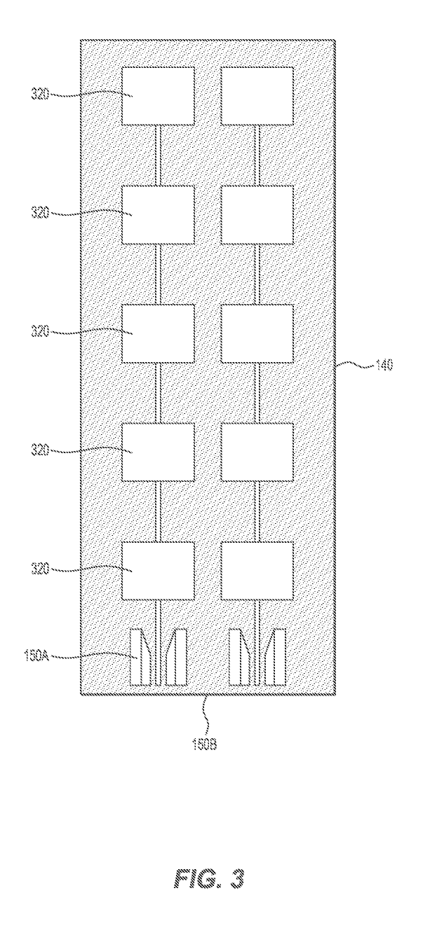

FIGS. 1A to 1C show an antenna unit 100 of a first embodiment that has two series-fed antenna arrays 150 on an antenna substrate in the form of a printed circuit board (PCB) 140. As best seen in FIG. 3, each of the antenna arrays 150A, 150B has five radiating antenna elements 321 that provide a primary radiation source for the antenna unit 100. In one example, the radiating antenna elements 321 are printed on a Taconic (PTFE) substrate of ∈ᵣ=2.2 and thickness of 254 μm. The width of the patches is 1.5 mm. The total length of the antenna including the feed line is 12 mm.

Referring to FIGS. 1A to 1C, it will be apparent that the lens structure of the antenna unit is formed from a hemispherical lens portion 110, a pair of opposing supporting walls 120A,120B extend from the base of the lens portion 110 to meet an annular base member 130 on which the PCB 140 is supported. A pair of recesses 160A, 160B, where the walls 120 meet the base member 130, are adapted to receive the PCB 140 and hold it in place. The PCB 140 can be put in place by sliding it into the recesses. It will be appreciated that the base member is spaced from the lens 110 by the walls 120 such that the PCB 140 is supported at an appropriate displacement relative to the lens with the plane of the PCB intersecting the focal length of the lens 110.

The base member 130 is annular so as to define a hollow interior portion 132 within inner wall 131 that provides room for one or more additional components to be affixed to the PCB 140. In this example, a CMOS chip 170 for generating the radar signal and/or processing the return radar signal is affixed to the PCB 140 by ball soldering.

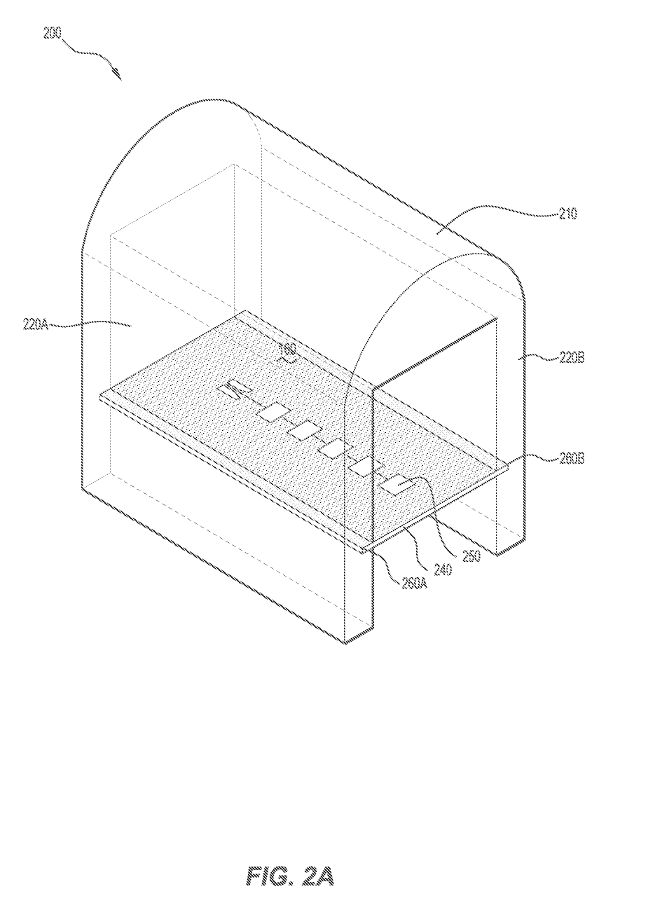

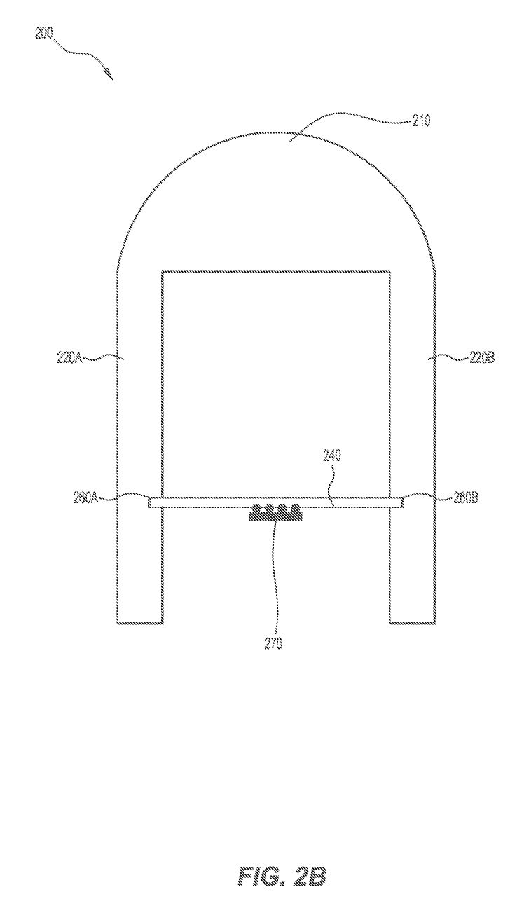

FIGS. 2A and 2B shows an antenna unit 200 of a second embodiment. In this embodiment, the lens structure has a cylindrical lens portion 210 supported by a pair of opposing walls 220A, 220B that extend from the base of the cylindrical lens portion 210. A pair of recesses 260A, 260B receive an antenna substrate in the form of PCB 240, in this example carrying radiating elements of one series-fed antenna array 250. The recesses 260 are positioned to appropriately space the radiating elements of the antenna from the lens 210.

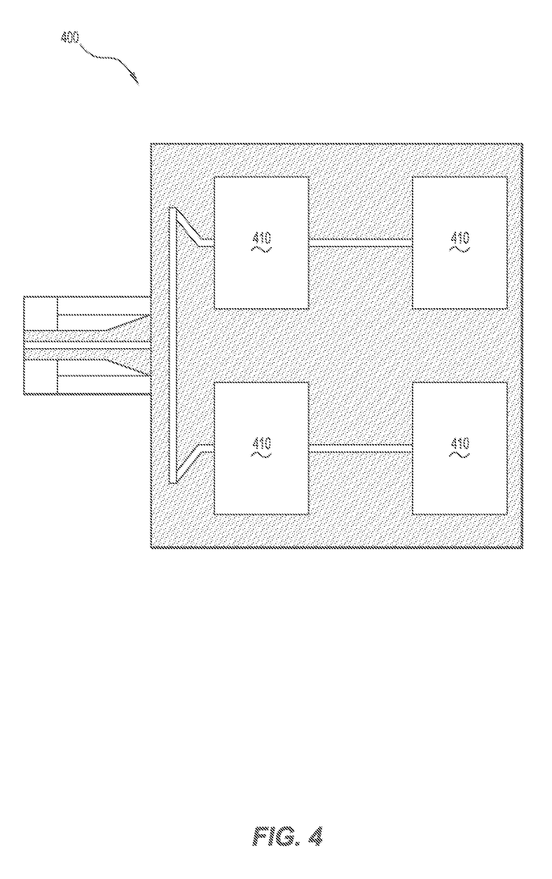

FIG. 4 illustrates an antenna array that may be used in another embodiment, in the form of 2×2 patch array 400 comprising four radiating elements of the antenna 410 on a PCB. Again array 400 is printed on Taconic (polytetrafluoroethylene) substrate of ∈ᵣ=2.2 and thickness of 254 μm. The size of the 2×2 patch array is 3.4 mm×3.85 mm and the overall size of the structure including the ground plane is 4.5 mm×4.3 mm. In order to obtain 50Ω input impedance matching the antenna feeding line includes the transition from the coplanar waveguide to the microstrip line.

It will be understood to persons skilled in the art of the invention that many modifications may be made without departing from the spirit and scope of the invention, in particular it will be apparent that certain features of embodiments of the invention can be employed to form further embodiments. For example, while the above embodiments describe walls that support the lens, legs or a skirt could be used instead. Further, the embodiment of FIG. 2 could have a third wall, closing one of the apertures between the pair of walls. Other variations will be apparent to those skilled in the art.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An antenna unit comprising:
an antenna substrate carrying one or more radiating elements; and
a lens structure formed of a dielectric material, the lens structure comprising a lens and at least one support member arranged to support the antenna substrate at a displacement relative to the lens.

2. The antenna unit as claimed in claim 1, wherein the support member is arranged to support the antenna substrate at a displacement relative to the lens where the plane of the antenna substrate intersects the focus of the lens.

3. The antenna unit as claimed in claim 1, wherein the lens is a hemispherical lens.

4. The antenna unit as claimed in claim 3, wherein said lens structure comprises a pair of walls extending from a base of the lens and joining the lens to a base member that provides the at least one support member.

5. The antenna unit as claimed in claim 4, comprising a pair of recesses in the integral lens structure where the walls meet the base member, each recess for receiving a portion of the antenna substrate.

6. The antenna unit as claimed in claim 4, wherein the base member is annular.

7. The antenna unit as claimed in claim 6, wherein the one or more radiating elements are carried on an obverse, lens-facing side of the antenna substrate and at least one additional component is attached to a reverse side of the antenna substrate in a position where it extends into an interior of the annular base member.

8. The antenna unit as claimed in claim 7, wherein the at least one additional component comprises a chip for driving the one or more radiating elements and/or processing signals received from the one or more radiating elements.

9. The antenna unit as claimed in claim 1, wherein the lens is a hemicylindrical lens.

10. The antenna unit as claimed in claim 1, wherein said at least one support structure comprises a pair of walls extending from a base of the lens, each wall having a recess for receiving and supporting a portion of the antenna substrate.

11. The antenna unit as claimed in claim 9, wherein the one or more antenna elements are carried on an obverse, lens-facing side of the antenna substrate and at least one additional component is attached to a reverse side of the antenna substrate.

12. The antenna unit as claimed in claim 11, wherein the at least one additional component comprises a chip for driving the one or more radiating elements and/or processing signals received from the one or more radiating elements.

13. The antenna unit as claimed in claim 1, wherein the one or more radiating elements are provided by one or more series-fed patch arrays.

14. The antenna unit as claimed in claim 1, wherein the one or more radiating elements are provided by at least one 2×2 patch array.

15. (canceled)

16. (canceled)

17. A lens structure for an antenna unit, the lens structure being formed of a dielectric material, the lens structure comprising a lens and at least one support member arranged to support an antenna substrate at a displacement relative to the lens.

18. The lens structure as claimed in claim 17, wherein the support member is arranged to support the antenna substrate at a displacement relative to the lens where the plane of the antenna substrate will intersect the focus of the lens.

19. The lens structure as claimed in claim 17, wherein the lens is a hemispherical lens.

20. The lens structure as claimed in claim 19, wherein said lens structure comprises a pair of walls extending from a base of the lens and joining the lens to a base member that provides the at least one support member.

21. The lens structure as claimed in claim 20, comprising a pair of recesses in the lens structure where the walls meet the base member, each recess for receiving a portion of the antenna substrate.

22. The lens structure as claimed in claim 20, wherein the base member is annular.

23. The lens structure as claimed in claim 17, wherein the lens is a hemicylindrical lens.

24. The lens structure as claimed in claim 23, wherein said at least one support structure comprises a pair of walls extending from a base of the lens and, each wall having a recess for receiving and supporting a portion of the antenna substrate.

25. The lens structure as claimed in claim 17, wherein the lens structure is formed from a low dielectric material.

26. The lens structure as claimed in claim 25, wherein the dielectric material is selected from a group including Teflon or Rexolite.
